(19) United States
(12) Patent Application Publication
(10) Pub. No.: US 2019/0180220 A1
(43) Pub. Date: Jun. 13, 2019

(54) PICKUP AND DELIVERY CONTROL SYSTEM AND PICKUP AND DELIVERY CONTROL METHOD

(71) Applicant: TOYOTA JIDOSHA KABUSHIKI KAISHA, Toyota-shi (JP)

(72) Inventors: Daiki KANEICHI, Nisshin-shi (JP); Kei KANAOKA, Nagoya-shi (JP); Shun MAEDA, Nisshin-shi (JP); Yoshihiro MUROZAKI, Nisshin-shi (JP); Hiroko TSUJIMURA, Nagoya-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/207,236

(22) Filed: Dec. 3, 2018

(30) Foreign Application Priority Data
Dec. 7, 2017 (JP) 2017-235516

(51) Int. Cl. G06Q 10/08; G06Q 50/30; G01C 21/34

(52) U.S. Cl. CPC G06Q 10/083; G01C 21/3438; G06Q 50/30

(57) ABSTRACT

A pickup and delivery control system that performs pickup and delivery of luggage at a vehicle shared in carsharing includes: an extraction unit configured to extract a target vehicles which is usable for pickup and delivery of the luggage based on a current position of a pickup and delivery user who picks up and delivers the luggage; an inquiry unit configured to notify a request user of position information of the target vehicle and an accessible time thereof and to inquire about whether to pick up and deliver the luggage at the target vehicle; and a determination unit configured to determine a pickup and delivery place and a pickup and delivery time of the luggage based on an inquiry result from the inquiry unit.

### INCORPORATION BY REFERENCE

The disclosure of Japanese Patent Application No. 2017-235516 filed on Dec. 7, 2017 including the specification, drawings and abstract is incorporated herein by reference in its entirety.

### BACKGROUND

### 1. Technical Field

The disclosure relates to a pickup and delivery control system and a pickup and delivery control method that are used for pickup and delivery of luggage at a vehicle which is shared in carsharing.

### 2. Description of Related Art

Recently, a trunk-sharing system in which a cargo compartment of a vehicle which is designated by a user is used as a pickup and delivery place of a delivery object have been developed as means for efficiently performing pickup and delivery of a delivery object (luggage) between a user of a pickup and delivery service and a delivery company carrying out pickup and delivery. For example, Japanese Unexamined Patent Application Publication No. 2006-206225 (JP 2006-206225 A) has proposed a system that performs an authentication process between a pickup and delivery communication device of a delivery company and a vehicle communication device mounted in a designated vehicle and allows locking and unlocking of the designated vehicle when the authentication has succeeded at the time of pickup and delivery of a delivery object.

### SUMMARY

Here, as a form of use of a vehicle by a plurality of users, a form of use of sharing the vehicle itself is known in addition to the form of use of the trunk-sharing system. In such a form of use, since a plurality of users share a vehicle mainly for the purpose of movement or the like, delivery of a key for driving the vehicle has to be managed (where a vehicle which is shared is referred to as a shared vehicle). In this case, the date and times or the time zones in which users want to use the vehicle are generally likely to be unbalanced. For example, an occupancy rate of a shared vehicle may be lower in the night time in which activities of users decrease than in the daytime in which activities increase. A usage trend of a shared vehicle differs between week days and weekends in a week. Since a state in which a vehicle is not being shared is a state in which there is little or no profit acquired from the vehicle, it is preferable that an occupancy rate of a vehicle be improved in view of economy.

In order to effectively utilize such shared vehicles, it is conceivable that the shared vehicles may be used for pickup and delivery of luggage in a trunk-sharing system. However, since a shared vehicle is shared for the purpose of driving thereof or the like, a place in which the shared vehicle is located may not be able to be said to be a place which is suitable for pickup and delivery of luggage. Accordingly, convenience for a user is not good when it is intended for the user to use a shared vehicle for pickup and delivery of luggage. In addition, since the user needs to move to the place at which the shared vehicle is located, the shared vehicle is occupied uselessly for a long time and thus there is a likelihood that usage of the shared vehicle in the original form of use will be hindered.

The disclosure provides a technique of efficiently using a vehicle which is shared in carsharing (a shared vehicle) for pickup and delivery of luggage.

The applicant of the disclosure has employed a configuration in which a vehicle which can be used for pickup and delivery of luggage among shared vehicles is extracted based on current position information of a pickup and delivery user who performs pickup and delivery of luggage and a request user who requests pickup and delivery of luggage is inquired of about whether the extracted vehicle is to be used. As a result, without hindering usage of a shared vehicle, it is possible to use the shared vehicle for pickup and delivery of luggage and thus to achieve an improvement in an occupancy rate of the shared vehicle.

More specifically, according to a first aspect of the disclosure, there is provided a pickup and delivery control system that performs pickup and delivery of luggage at a vehicle shared in carsharing, the pickup and delivery control system including: an extraction unit configured to extract one or more target vehicles which are not being shared within a predetermined time range from a current time and which are usable for pickup and delivery of the luggage, from among a plurality of vehicles based on a current position of a pickup and delivery user who picks up and delivers the luggage; an inquiry unit configured to notify a request user who requests pickup and delivery of the luggage of position information of the extracted target vehicle and an accessible time which is within the predetermined time range and at which the target vehicle is accessible and to inquire of the request user about whether to pick up and deliver the luggage at the target vehicle; and a determination unit configured to determine a pickup and delivery place and a pickup and delivery time of the luggage based on an inquiry result from the inquiry unit.

The pickup and delivery control system according to the aspect is a system that efficiently performs pickup and delivery of luggage at a vehicle shared in carsharing (hereinafter referred to as a “shared vehicle”). Accordingly, vehicles serving as a control target in the pickup and delivery control system are limited to shared vehicles. In the disclosure, the sharing type of vehicles in the carsharing is not particularly limited. For example, persons who can share vehicles may be limited to a specific number of users, or may not be limited thereto. Regarding a key for driving a shared vehicle, a physical key may be delivered between users or an electronic key for driving may be issued and delivered to users. The shared vehicles are not limited to specific types of vehicles, and include various vehicles such as vehicles with an internal combustion engine as a drive source, electric vehicles, and fuel-cell vehicles.

In the pickup and delivery control system, the extraction unit is configured to extracts one or more target vehicles from a plurality of shared vehicles. Here, a target vehicle is a shared vehicle which is not being shared within a predetermined time range from the current time and which is usable for pickup and delivery of luggage. In this way, the target vehicles are extracted from only shared vehicles which are not being shared within a limited range including the current time. The predetermined time range is a time range which does not affect the carsharing much, and an example thereof is a relatively short time such as 30 minutes or one hour. Accordingly, the predetermined time range from the current time refers to a time range in the relatively near future from the current time. By extracting the target vehicles within a limited time range in this way, it is possible to minimize an influence on carsharing as much as possible and to achieve an improvement in the occupancy rate using the shared vehicles for pickup and delivery of luggage.

The target vehicles are extracted by the extraction unit based on the current position of a pickup and delivery user who picks up and delivers luggage. The pickup and delivery user is a user who picks up and delivers luggage based on a request associated with pickup and delivery of luggage form a request user. Specifically, when a request user has requested delivery of luggage, the pickup and delivery user delivers the luggage to a target vehicle. When a request user has requested pickup of luggage, the pickup and delivery user picks up the luggage at a target vehicle. That is, the pickup and delivery user needs to reach a place in which the target vehicle is located for pickup and delivery of luggage in accordance with a request from a request user. By causing the extraction unit to extract the target vehicles based on the current position of the pickup and delivery user in consideration of the above description, it is possible to reduce labor for the pickup and delivery user reaching the target vehicle, which secures convenience for the pickup and delivery user and shortens a time in which the target vehicle which was originally provided for carsharing is occupied for pickup and delivery of luggage.

Further, the inquiry unit is configured to inquire of the request user about whether to pick up and deliver luggage using the target vehicle extracted by the extraction unit. At this time, the request user is notified of the position information of the target vehicle and the accessible time for the target vehicle for pickup and delivery of luggage. Accordingly, the request user can determine whether pickup and delivery of the luggage using the target vehicle extracted by the extraction unit is suitable for the request user and it is also possible to secure convenience for the request user. The accessible time is a time within a predetermined time range and the accessible time may be, for example, a time zone corresponding to the predetermined time range or may be a part of a time zone of the predetermined time range in another method. The accessible time may not deviate from the predetermined time range. Accordingly, it is possible to limit a time in which the target vehicle can be used for pickup and delivery of luggage and thus to avoid hindering of original usage of the shared vehicle.

Then, the determination unit is configured to determine the pickup and delivery place and the pickup and delivery time of the luggage such that pickup and delivery of luggage in the accessible time at the target vehicle is possible in consideration of the inquiry result from the inquiry unit. In this way, with the pickup and delivery control system according to the disclosure, it is possible to avoid hindering of usage of a shared vehicle shared in carsharing and to improve an occupancy rate of the shared vehicle by efficiently using the shared vehicle for pickup and delivery of luggage.

In the aspect, the extraction unit may be configured to extract the one or more target vehicles based on predetermined pickup and delivery information on the luggage. According to this configuration, it is possible to extract a target vehicle which is suitable for picking up and delivering luggage at the target vehicle. The predetermined pickup and delivery information is information on luggage which is loaded into the target vehicle. Therefore, examples of the predetermined pickup and delivery information include physical information such as a shape or a weight of luggage, information indicating whether the pickup and delivery performed by the pickup and delivery user is delivery or pickup of the luggage, and information on high-temperature resistance of luggage and whether it is waterproof.

In the configuration, the pickup and delivery control system may further include an occupancy rate information acquiring unit configured to acquire occupancy rate information on the one or more target vehicles within the predetermined time range from the current time. The occupancy rate information is acquired by calculating a carsharing rate in a predetermined period over a plurality of days (for example, one week or one month) for each hour. In this case, the inquiry unit may be configured to notify the request user of a part or all of a time zone in which an occupancy rate is equal to or less than a predetermined occupancy rate as the accessible time when the time zone in which the occupancy rate is equal to or less than the predetermined occupancy rate is included in the predetermined time range. According to this configuration, by preferentially using a time zone in which the occupancy rate in carsharing is relatively low for delivery of luggage, it is possible to use a target vehicle for pickup and delivery of luggage without hindering usage of the target vehicle in carsharing and to further effectively enhance the occupancy rate.

In the aspect, the inquiry unit may be configured to inquire of the request user such that one of a plurality of accessible times belonging to the predetermined time range is selected. By inquiring of the request user about a plurality of accessible time, it is possible to increase options of the request user and to improve convenience.

In the aspect, the luggage may be scheduled to be picked up and delivered at a predetermined place associated with the request user by a pickup and delivery user, and the extraction unit may be configured to extract the target vehicle instead of the predetermined place as a new pickup and delivery place of the luggage when a request for changing the pickup and delivery place of the luggage is issued from the request user. By causing the extraction unit to extract a target vehicle with a request for change of the pickup and delivery place from the request user as a trigger in this way, it is possible to enhance convenience for the request user and to achieve an improvement in the occupancy rate of a shared vehicle.

The pickup and delivery control system according to the disclosure may be configured as one or more processors such as a computer. When the pickup and delivery control system includes a plurality of processors, the elements of the pickup and delivery control system are distributed in the plurality of processors, and the processors realize the functions of the pickup and delivery control system in cooperation with each other.

The disclosure may be understood as an aspect of a pickup and delivery control method for performing pickup and delivery of luggage at a vehicle shared in carsharing. According to a second aspect of the disclosure, there is provided a pickup and delivery control method for performing pickup and delivery of luggage at a vehicle shared in carsharing, the pickup and delivery control method including: extracting one or more target vehicles which are not being shared within a predetermined time range from a current time and which are usable for pickup and delivery of the luggage, from among a plurality of vehicles based on a current position of a pickup and delivery user who picks up and delivers the luggage; notifying a request user who requests pickup and delivery of the luggage of position information of the extracted target vehicle and an accessible time which is within the predetermined time range and at which the target vehicle is accessible and inquiring of the request user about whether to pick up and deliver the luggage at the target vehicle; and determining a pickup and delivery place and a pickup and delivery time of the luggage based on an inquiry result. The technical concept disclosed in association with the above-mentioned pickup and delivery control system can also be applied to the pickup and delivery control method without causing a technical mismatch.

In the aspect, the extracting of the one or more target vehicles may include extracting the one or more target vehicles based on predetermined pickup and delivery information on luggage. In this configuration, the pickup and delivery control method may further include acquiring operation rate information on the one or more target vehicles within the predetermined time range from the current time, and the inquiring about whether to pick up and deliver luggage at the target vehicle may include notifying the request user of a part or all of a time zone in which an operation rate is equal to or less than a predetermined operation rate as the accessible time when the time zone in which the operation rate is equal to or less than the predetermined operation rate is included in the predetermined time range.

According to the aspect, it is possible to efficiently use vehicles which are shared in carsharing (a shared vehicle) for pickup and delivery of luggage.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram schematically illustrating a configuration of a carsharing system in which a pickup and delivery control system according to an embodiment of the disclosure is constructed;

FIG. 2 is a diagram illustrating detailed configurations of a user terminal, a center server, and a sharing management server which are associated with carsharing and which are included in the carsharing system;

FIG. 3A is a diagram illustrating a data structure of carsharing management information;

FIG. 3B is a diagram illustrating a data structure of vehicle management information associated with a shared vehicle;

FIG. 4 is a diagram illustrating detailed configurations of an onboard device of a shared vehicle and a user terminal, a center server, and a pickup and delivery management server associated with pickup and delivery of luggage, all of which are included in the carsharing system;

FIG. 5 is a diagram illustrating a data structure of pickup and delivery information associated with luggage which is picked up and delivered;

FIG. 6 is a first diagram illustrating the concept for extracting a target vehicle which is used for pickup and delivery of luggage from shared vehicles;

FIG. 7 is a flowchart illustrating pickup and delivery control which is executed by the center server according to the embodiment of the disclosure;

FIG. 8 is a second diagram illustrating the concept for extracting a target vehicle which is used for pickup and delivery of luggage from shared vehicles; and

FIG. 9 is a diagram illustrating change of an occupancy rate of a shared vehicle in the carsharing system.

### DETAILED DESCRIPTION OF EMBODIMENTS

Hereinafter, a specific embodiment of the disclosure will be described with reference to the accompanying drawings. Configurations described in the embodiment are not intended to limit a technical scope of the disclosure to the configurations unless particularly described thus.

### System Configuration

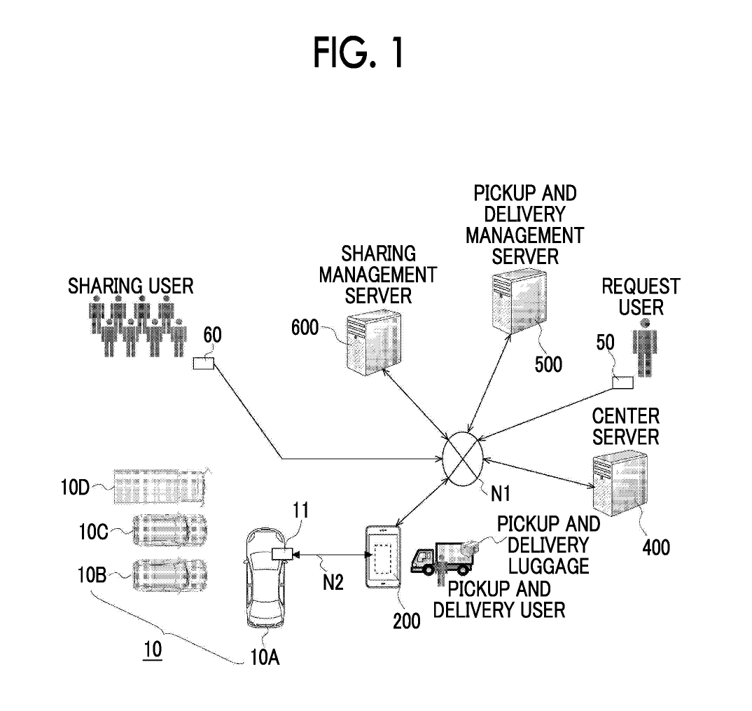

FIG. 1 is a diagram schematically illustrating a configuration of a carsharing system and a configuration of a trunk-sharing system including a pickup and delivery control system which uses vehicles managed by the carsharing system (shared vehicles) for pickup and delivery of luggage. The carsharing system is a system that manages a plurality of shared vehicles 10 which are used by sharing users, and performs, for example, reservation management for sharing users of the shared vehicles 10 or management of usage fees thereof. In this embodiment, when the shared vehicles are collectively mentioned, the reference sign thereof is 10. When individual shared vehicles are designated, a suffix for identifying each vehicle is added thereto and a reference sign is added thereto like 10A or the like. In FIG. 1, four shared vehicles 10A to 10D are illustrated as an example. It is assumed that the shared vehicles 10 are generally parked in predetermined parking places when the shared vehicles 10 are not being used by users. The parking places of the shared vehicles do not have to be the same place.

In the example illustrated in FIG. 1, the carsharing system includes user terminals 60 of sharing users and a sharing management server 600. The user terminals 60 and the sharing management server 600 are connected to each other via a network N1. The network N1 may be, for example, a global public communication network such as the Internet, but a wide area network (WAN) or other communication networks may be employed. The network N1 may include a telephone communication network of mobile phones and the like and a wireless communication network such as WiFi. It is preferable that the sharing users register their identification information in the sharing management server 600 before using the carsharing system.

The sharing management server 600 receives usage reservation of a shared vehicle 10 from the user terminal 60 of a sharing user. In the reservation process, a sharing user inputs a shared vehicle which the user wants to use, a date and time at which the user wants to use the shared vehicle, and the like via the user terminal 60, and the sharing management server 600 determines whether the vehicle may be used. When it is determined that the designated shared vehicle 10 can be reserved, the sharing management server 600 manages usage of the shared vehicle such that another sharing user cannot use the shared vehicle at the same date and time thereafter. The sharing management server 600 also performs processes such as change of the received reservation of the shared vehicle (such as change of the date and time of use or change of a target vehicle) and cancelling the reservation.

In the carsharing system according to this embodiment, it is possible to achieve an improvement in an occupancy rate of shared vehicles by also using the shared vehicles which are managed as pickup and delivery places of luggage. A trunk-sharing system which is constructed for pickup and delivery of luggage includes the pickup and delivery control system, a cargo compartment (a trunk room) of a shared vehicle 10 is commonly used (shared) by a person who requests pickup and delivery work of a delivery object (luggage) and a person who performs pickup and delivery work of the requested delivery object under the control of the pickup and delivery control system, and a pickup and delivery service using the cargo compartment as a pickup and delivery place is realized. That is, the trunk-sharing system also shares vehicles which are shared in the carsharing system additionally for pickup and delivery of luggage. A “person who requests pickup and delivery work of a delivery object” and a “person who performs pickup and delivery work of a delivery object” are users who use cargo compartments of the shared vehicles, and the former is referred to as a “request user” and the latter is referred to as a “pickup and delivery user” to distinguish both persons from each other. The request user and the pickup and delivery user do not have to be users included in sharing users in the carsharing system. The cargo compartment is a predetermined area of a shared vehicle 10 in which luggage to be picked up and delivered can be disposed and which is configured to be locked/unlocked by an onboard device 11 as will be described later. The cargo compartment is an area which is partitioned from a passenger compartment in which a driver or the like of the shared vehicle 10 is located such that the cargo compartment and the passenger compartment cannot access each other.

In the example illustrated in FIG. 1, the trunk-sharing system includes an onboard device 11 that is installed in each shared vehicle 10, a user terminal 200 of a pickup and delivery user, a user terminal 50 of a request user, a center server 400, and a pickup and delivery management server 500. In this embodiment, a pickup and delivery control system is constituted by the center server 400. The onboard device 11, a user terminal 200, the user terminal 50, the center server 400, and the pickup and delivery management server 500 are connected to each other via the network N1 to which the sharing management server 600 is also connected. The onboard device 11 is connected to the user terminal 200 of a pickup and delivery user via a network N2 including short-range wireless communication or the like.

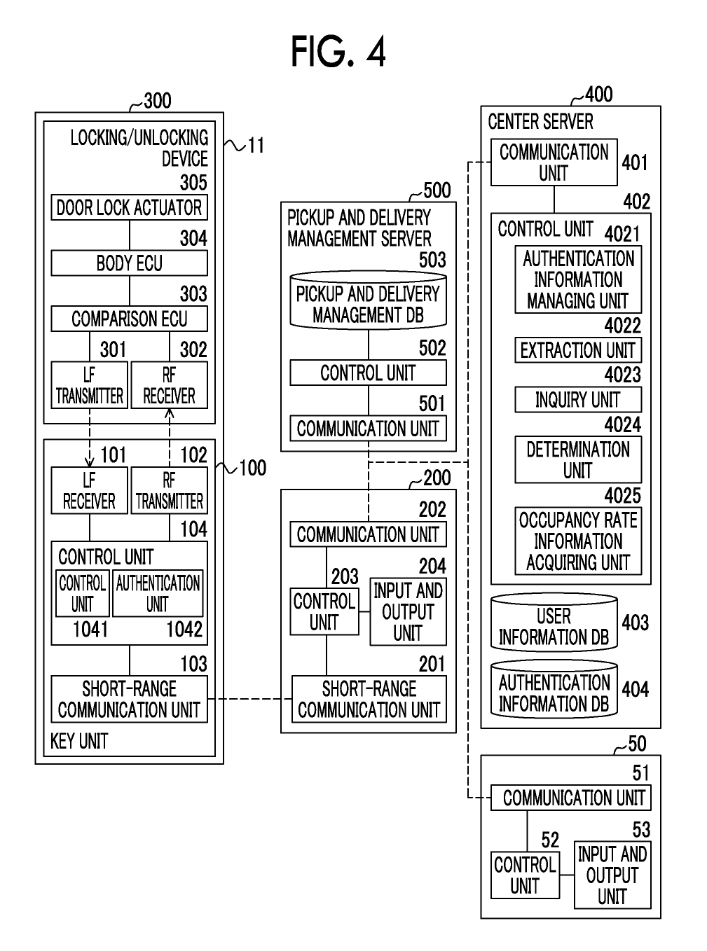

The pickup and delivery management server 500 receives registration of an article to be picked up and delivered (hereinafter also referred to as a “pickup and delivery luggage”) from the user terminal 50 of the request user. For example, when the request user has a pickup and delivery user deliver an article purchased from a product purchase site opened by an electronic transaction provider to a shared vehicle 10 as pickup and delivery luggage, whether to pick up and deliver the pickup and delivery luggage at the shared vehicle 10 is determined by pickup and delivery control performed by the center server 400 which will be described later. As a result, when pickup and delivery at the shared vehicle 10 is possible, pickup and delivery information on the pickup and delivery luggage is registered in the pickup and delivery management server 500. The pickup and delivery information includes identification information of the request user, schedule information of delivery and pickup, and information on attributes of pickup and delivery luggage as illustrated in FIG. 4 to be described later.

When a request for pickup and delivery of luggage is received from the user terminal 50 of a request user and the pickup and delivery place thereof is the shared vehicle 10, the pickup and delivery management server 500 requests the center server 400 to issue authentication for locking/unlocking a cargo compartment of the shared vehicle 10 in which the pickup and delivery luggage is accommodated to the user terminal 200 of the pickup and delivery user. The request is transmitted with a request from the user terminal 200 of a pickup and delivery user as a trigger. The center server 400 transmits authentication information of the shared vehicle 10 as the pickup and delivery place included in the pickup and delivery information to the user terminal 200 of the pickup and delivery user via the pickup and delivery management server 500. The pickup and delivery user can access the cargo compartment of the shared vehicle 10 to deliver and pick up the pickup and delivery luggage by locking/unlocking the cargo compartment of the shared vehicle 10 using the authentication information acquired by the user terminal 200. Here, the authentication information is digital information which is used to allow the onboard device 11 to perform a locking/unlocking process for the cargo compartment of the shared vehicle 10 by being transmitted from the user terminal 200 to the onboard device 11 by short-range wireless communication and being subjected to an authentication process by the onboard device 11. The locking/unlocking process for the cargo compartment of the shared vehicle 10 is a process of locking/unlocking a door of the cargo compartment of the shared vehicle 10 in which pickup and delivery luggage is accommodated using the onboard device 11 of which details will be described later.

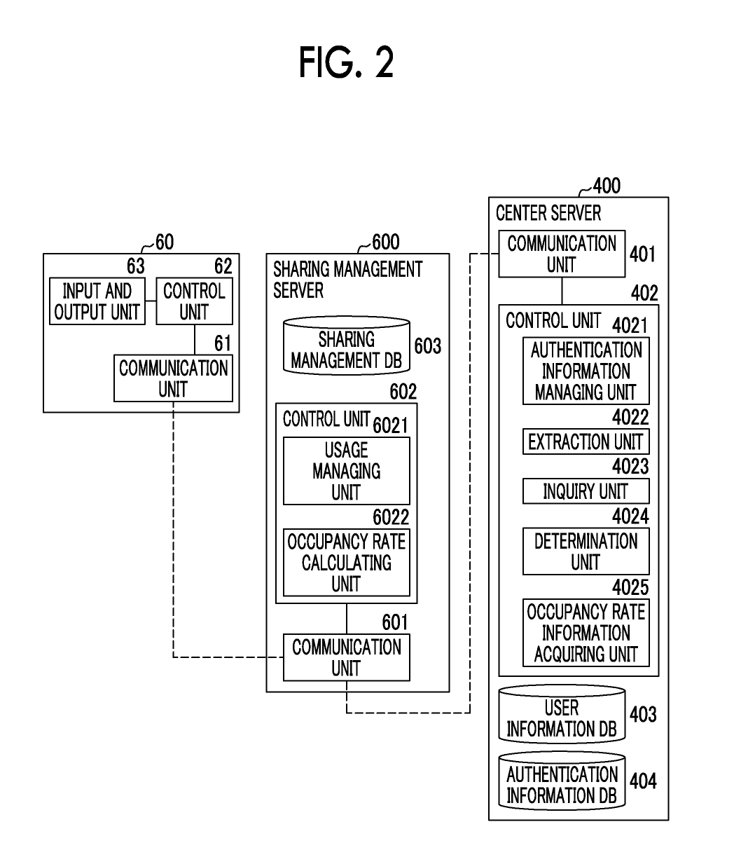

A hardware configuration and a functional configuration of the user terminal 60 of a sharing user and the sharing management server 600 which are configurations associated with the carsharing system in the system configuration illustrated in FIG. 1 will be described below with reference to FIG. 2. The center server 400 is also illustrated to show connection between the sharing management server 600 and the center server 400 in FIG. 2, and a hardware configuration and a functional configuration of the center server 400 will be described later with reference to FIG. 4.

First, the user terminal 60 of a sharing user will be described below. The user terminal 60 is, for example, a small computer such as a smartphone, a mobile phone, a tablet terminal, a personal information terminal, or a wearable computer (such as a smart watch). The user terminal 60 may be a personal computer (PC) that is connected to the sharing management server 600 via the network N1 such as the Internet which is a public communication network. The user terminal 60 of a sharing user includes a communication unit 61, a control unit 62, and an input and output unit 63.

The communication unit 61 is communication means that connects the user terminal 60 to the network N1. In this embodiment, the user terminal 60 can communicate with another device (such as the sharing management server 600) via the network N1 using a mobile communication service such as 3G (3^{rd} Generation) or LTE (Long Term Evolution). The control unit 62 is a computer that takes charge of control of the user terminal 60. The control unit 62 is constituted, for example, by a microcomputer and realizes functions of various processes by causing a CPU (not illustrated) to execute a program stored in storage means (such as a ROM). For example, the control unit 62 executes a predetermined application such that request for a reservation, update of a reservation, and the like of the shared vehicle 10 are performed on the sharing management server 600 via the input and output unit 63. The input and output unit 63 is means that receives an input operation performed by a sharing user and provides information to the sharing user. Specifically, the input and output unit 63 includes a touch panel and control means thereof and a liquid crystal display and control means thereof. The touch panel and the liquid crystal display are constituted as a single touch panel display in this embodiment.

The sharing management server 600 will be described now. The sharing management server 600 has a configuration of a general computer and is, for example, a computer including a processor (not illustrated) such as a central processing unit (CPU) or a digital signal processor (DSP), a main storage unit (not illustrated) such as a random access memory (RAM) and a read only memory (ROM), and an auxiliary storage unit (not illustrated) such as an erasable programmable ROM (EPROM), a hard disk drive (HDD), and a removable medium. The removable medium is, for example, a universal serial bus (USB) memory or a disk recording medium such as a compact disc (CD) or a digital versatile disc (DVD). An operating system (OS), various programs, various tables, and the like are stored in the auxiliary storage unit, and functions matching a predetermined purpose can be realized by loading a program stored therein into a work area of the main storage unit, executing the loaded program, and controlling the constituent units through execution of the program.

The sharing management server 600 includes a communication unit 601. The communication unit 601 is connected to another device and performs communication between the sharing management server 600 and the other device (for example, the user terminal 60 or the center server 400). The communication unit 601 is, for example, a local area network (LAN) interface board and a wireless communication circuit for wireless communication. The LAN interface board or the wireless communication circuit is connected to the network N1 such as the Internet which is a public communication network.

The sharing management server 600 includes a sharing management database (DB) 603 that stores information for managing usage situations including a reservation and the like of the shared vehicle 10. The sharing management DB 603 is configured to store management information in the auxiliary storage unit. The sharing management DB 603 is constructed by causing a program of a database management system (DBMS) which is executed by the processor to manage data stored in the auxiliary storage unit. The sharing management DB 603 is, for example, a relational database. For example, management information for managing sharing for each shared vehicle 10 and vehicle management information on each shared vehicle 10 are stored in the sharing management DB 603.

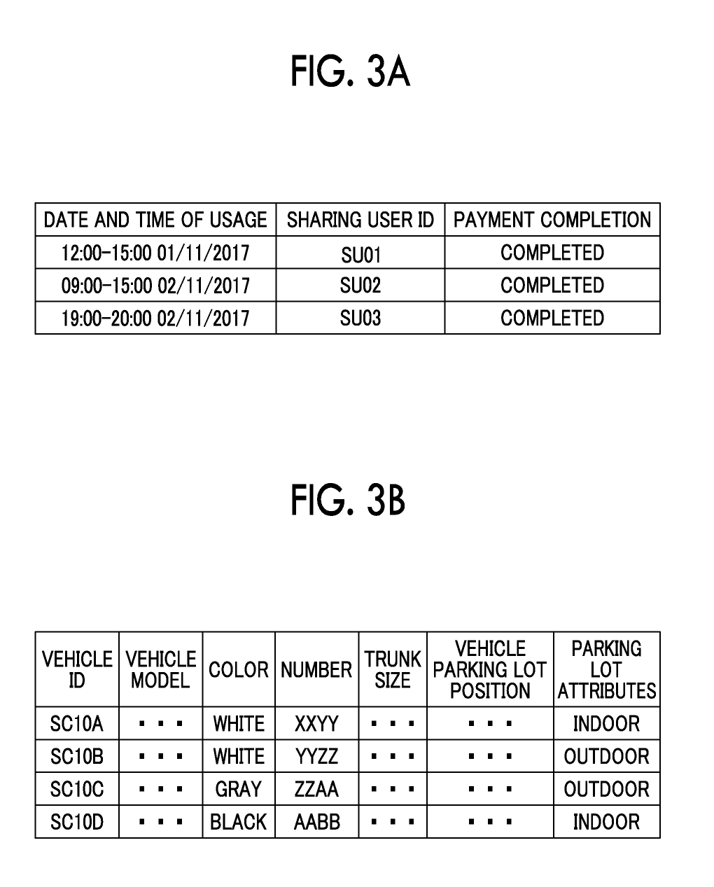

A configuration of management information stored in the sharing management DB 603 will be described below with reference to FIG. 3A. FIG. 3A illustrates a table configuration of management information, a management information table is prepared for each of all the shared vehicles 10 which are managed by the sharing management server 600, and each management information table includes fields of a usage date and time, a sharing user ID, and payment completion. Information indicating a time zone in which the shared vehicle is used is input to the field of usage date and time. Identification information for identifying the sharing user is input to the field of sharing user ID. Information indicating whether payment of usage fee has been completed by the sharing user in usage of the shared vehicle 10 is input to the field of payment completion. For example, “completed” is input when payment has been completed, and “not completed” is input when payment has not been completed.

The configuration of vehicle management information stored in the sharing management DB 603 will be described below with reference to FIG. 3B. FIG. 3B illustrates a table configuration of vehicle management information, and a vehicle management information table includes a field of vehicle model, a field of vehicle color, and a field of vehicle number to which information (a vehicle model, a vehicle color, and a vehicle number) for identifying the shared vehicle 10 is input. The vehicle management information table includes a field of trunk size to which a trunk size in which luggage can be accommodated is input. The vehicle management information table also includes a field of vehicle parking lot position to which parking lot position information of the shared vehicle 10 is input and a field of parking lot attribute indicating whether the parking lot is an indoor parking lot or an outdoor parking lot. Since a shared vehicle 10 is used by many sharing users, the position at which the shared vehicle 10 is parked before sharing is a predetermined position, and the position information is input to the field of parking lot position information. An input to the field of parking lot attribute is determined depending on whether the parking environment at the predetermined position is indoor or outdoor.

In the sharing management server 600, a control unit 602 is realized as a function unit by causing the processor to execute a program. The control unit 602 performs management control such as registration or update of management information in the sharing management DB 603 and includes a usage managing unit 6021 and an occupancy rate calculating unit 6022 which are functional units for the purpose thereof. The usage managing unit 6021 performs processes associated with use of the shared vehicles 10 in carsharing, processes of generating and updating management information stored in the sharing management DB 603, and the like in accordance with a request from the user terminal 60. The occupancy rate calculating unit 6022 is a functional unit that calculates an occupancy rate for each hour for each shared vehicle 10 which are managed by the sharing management server 600. The occupancy rate is calculated for each hour of one day (24 hours) as illustrated in FIG. 9 which will be described later, and usage situations of the shared vehicle 10 in a predetermined period of a plurality of days (for example, latest 30 days) are reflected in the calculation thereof. For example, when a shared vehicle is used for carsharing for one hour from 12:00 to 13:00 of 15 days among the latest 30 days, the occupancy rate corresponding to the time zone is calculated to be 50%. The management information stored in the sharing management DB 603 is used for calculation of the occupancy rate by the occupancy rate calculating unit 6022.

One of the functional elements of the sharing management server 600 or some of the processes thereof may be embodied by another computer connected to the network N1. A sequence of processes which are performed by the sharing management server 600 may be implemented in hardware or may be implemented in software.

FIG. 4 is a block diagram schematically illustrating the configurations of the onboard device 11, a user terminal 200 of a pickup and delivery user, a user terminal 50 of a request user, the pickup and delivery management server 500, and the center server 400 which constitute a trunk-sharing system using shared vehicles 10. The hardware configurations and the functional configurations of the onboard device 11, the user terminal 200 of a pickup and delivery user, the user terminal 50 of a request user, the pickup and delivery management server 500, and the center server 400 will be described below with reference to FIG. 4.

The onboard device 11 includes a key unit 100 and a locking/unlocking device 300. The key unit 100 includes the same wireless interface as an electronic key (hereinafter referred to as a portable unit) such as a smart key, and can perform locking and unlocking of a cargo compartment or a passenger compartment of a shared vehicle 10 (hereinafter may be referred to as “locking and unlocking of a shared vehicle 10” when the cargo compartment and the passenger compartment do not need to be distinguished) without using any physical key by communication with the existing locking/unlocking device 300 of the onboard device 11. The key unit 100 performs short-range wireless communication with the user terminal 200 of a pickup and delivery user and determines whether it serves as an electronic key of the shared vehicle 10 based on the result of an authentication process on the user terminal 200 of the pickup and delivery user.

The user terminal 200 of a pickup and delivery user receives authentication information for locking and unlocking the cargo compartment, which is issued by the center server 400, via the pickup and delivery management server 500 as described above when accessing the cargo compartment of the shared vehicle 10 for delivering and picking up pickup and delivery luggage. Then, the authentication information transmitted from the user terminal 200 of a pickup and delivery user to the key unit 100 is compared with authentication information stored in advance in the key unit 100. When the authentication process succeeds, the user terminal 200 is authenticated as a terminal that rightly operates the onboard device 11. When the user terminal 200 is authenticated, the key unit 100 transmits a key ID of the shared vehicle 10 stored in advance in the key unit 100 and correlated with the authentication information to the locking/unlocking device 300 along with a locking/unlocking signal. The locking/unlocking device 300 locks or unlocks the shared vehicle 10 when the key ID received from the key unit 100 matches a key ID stored in advance in the locking/unlocking device 300. The key unit 100 and the locking/unlocking device 300 operate with electric power supplied from a battery mounted in the shared vehicle 10. The key ID stored in advance in the key unit 100 may be encrypted with the authentication information. In this case, the key unit 100 can decrypt the key ID with the authentication information and transmit the key ID to the locking/unlocking device 300 when the authentication process of the user terminal 200 of a pickup and delivery user succeeds.

Details of the locking/unlocking device 300 will be described below. The locking/unlocking device 300 is a device that locks and unlocks a door of the passenger compartment or the cargo compartment of the shared vehicle 10. For example, the locking/unlocking device 300 locks and unlocks the door of the shared vehicle 10 in accordance with a locking signal and an unlocking signal which are transmitted from the portable unit corresponding to the shared vehicle 10 using radio waves of a radio frequency (hereinafter referred to as RF) band. The locking/unlocking device 300 also has a function of transmitting radio waves of a low frequency (hereinafter referred to as LF) band for retrieving the portable unit.

In this embodiment, the key unit 100 instead of the portable unit controls locking and unlocking of the door of the shared vehicle 10 by transmitting and receiving radio waves of the RF band and the LF band to and from the locking/unlocking device 300. In the following description, unless mentioned otherwise, the communication destination of the locking/unlocking device 300 is limited to the key unit 100.

The locking/unlocking device 300 includes an LF transmitter 301, an RF receiver 302, a comparison ECU 303, a body ECU 304, and a door lock actuator 305. The LF transmitter 301 is means that transmits radio waves of the LF band (for example, 100 KHz to 300 KHz) for retrieving (polling) the key unit 100. The LF transmitter 301 is incorporated, for example, in the vicinity of a center console or a steering wheel in the passenger compartment. The RF receiver 302 is means that receives radio waves of the RF band (for example, 100 MHz to 1 GHz) transmitted from the key unit 100. The RF receiver 302 is incorporated in the passenger compartment.

The comparison ECU 303 is a computer that performs control for locking and unlocking the door of the passenger compartment or the cargo compartment of the shared vehicle 10 based on a signal (a locking signal or an unlocking signal) transmitted from the key unit 100 using the radio waves of the RF band. The comparison ECU 303 is constituted, for example, by a microcomputer. In the following description, the locking signal and the unlocking signal are collectively referred to as a locking/unlocking signal. The term, locking/unlocking signal, represents any one of the locking signal and the unlocking signal.

The comparison ECU 303 authenticates whether the locking/unlocking signal transmitted from the key unit 100 is transmitted from a rightful device. Specifically, the comparison ECU 303 determines whether the key ID included in the locking/unlocking signal matches the key ID stored in advance in a storage unit (not illustrated) in the comparison ECU 303. Then, the comparison ECU 303 transmits an unlocking command or a locking command to the body ECU 304 based on the determination result. The unlocking command or the locking command is transmitted via an onboard network such as a controller area network (CAN).

The door lock actuator 305 is an actuator that locks and unlocks the door of the shared vehicle 10 (such as a passenger compartment door which is opened and closed at the time of getting on and off the passenger compartment as an inside space or a cargo compartment door which is opened and closed at the time of loading luggage at the cargo compartment). The door lock actuator 305 operates based on a signal transmitted from the body ECU 304. The door lock actuator 305 may be configured to independently lock and unlock the passenger compartment door and the cargo compartment door of the shared vehicle 10.

The body ECU 304 is a computer that executes body control of the shared vehicle 10. The body ECU 304 has a function of simultaneously or independently performing unlocking and locking of the passenger compartment door or the cargo compartment door of the shared vehicle 10 by controlling the door lock actuator 305 based on the unlocking command or the locking command received from the comparison ECU 303. The comparison ECU 303 and the body ECU 304 may be embodied as a single body.

The key unit 100 will be described now. The key unit 100 is a device that is disposed at a predetermined position (for example, inside a glove box) of the passenger compartment of the shared vehicle 10. The key unit 100 has a function of authenticating the user terminal 200 by performing short-range radio communication with the user terminal 200 of a pickup and delivery user and a function of transmitting the locking/unlocking signal using radio waves of the RF band based on the authentication result. The key unit 100 includes an LF receiver 101, an RF transmitter 102, a short-range communication unit 103, and a control unit 104.

The LF receiver 101 is means that receives a polling signal transmitted from the locking/unlocking device 300 using radio waves of the LF band. The LF receiver 101 includes an antenna for receiving radio waves of the LF band (hereinafter referred to as an LF antenna). The RF transmitter 102 is means that transmits a locking/unlocking signal to the locking/unlocking device 300 using radio waves of the RF band.

The short-range communication unit 103 is means that communicates with the user terminal 200 of a pickup and delivery user. The short-range communication unit 103 performs communication in a short range (at a distance at which the interior and the exterior of the vehicle can communicate with each other) using a predetermined radio communication standard. In this embodiment, the short-range communication unit 103 performs data communication based on a Bluetooth (registered trademark) Low Energy standard (hereinafter referred to as BLE). BLE is a low-energy communication standard using Bluetooth, and is characterized in that communication can be started immediately when a communication partner is detected without requiring pairing between devices. In this embodiment, BLE is exemplified, but another radio communication standard can also be used. For example, near field communication (NFC), ultra wideband (UWB), or WiFi (registered trademark) may be used.

The control unit 104 is a computer that performs short-range radio communication with the user terminal 200 of a pickup and delivery user via the short-range communication unit 103 and performs control for authenticating the user terminal 200 and control for transmitting a locking/unlocking signal based on the authentication result. The control unit 104 is constituted, for example, by a microcomputer.

The control unit 104 includes a storage unit 1041 and an authentication unit 1042. A control program for controlling the key unit 100 is stored in the storage unit 1041. The control unit 104 may realize various functional units including the authentication unit 1042 by causing a CPU which is not illustrated to execute the control program stored in the storage unit 1041. For example, the control unit 104 realizes a function of receiving a polling signal transmitted as radio waves of the LF band from the locking/unlocking device 300 via the LF receiver 101, a function of transmitting a locking/unlocking signal as radio waves of the RF bands to the locking/unlocking device 300 via the RF transmitter 102, a function of processing communication with the user terminal 200 of a pickup and delivery user which is performed by the short-range communication unit 103, and a function of generating a locking/unlocking signal when authentication of the user terminal 200 of a pickup and delivery user by the authentication unit 1042 has succeeded.

The authentication unit 1042 authenticates the user terminal 200 based on authentication information included in a locking request or an unlocking request (hereinafter collectively referred to as a locking/unlocking request) transmitted from the user terminal 200 of a pickup and delivery user. Specifically, the authentication unit 1042 compares the authentication information transmitted from the user terminal 200 of a pickup and delivery user with the authentication information stored in the storage unit 1041 and determines that the authentication has succeeded when they have a predetermined relationship. When both pieces of the authentication information do not satisfy the predetermined relationship, the authentication unit 1042 determines that the authentication has failed. Here, the predetermined relationship includes a case in which the authentication information stored in the storage unit 1041 matches the authentication information transmitted from the user terminal 200 of a pickup and delivery user, a case in which results of predetermined processes such as encryption and decryption using the two pieces of authentication information match each other, and a case in which a result of decryption on one of the two pieces of authentication information matches that on the other thereof.

When the authentication of the user terminal 200 of a pickup and delivery user by the authentication unit 1042 has succeeded, a locking/unlocking signal generated in response to a request received from the user terminal 200 is transmitted to the locking/unlocking device 300 via the RF transmitter 102. In the following description, the authentication information stored in the key unit 100 is referred to as device authentication information and the authentication information transmitted from the user terminal 200 of a pickup and delivery user is referred to as terminal authentication information, if necessary.

The key unit 100 transmits the key ID along with the locking/unlocking signal to the locking/unlocking device 300. The key ID may be stored in the key unit 100 in a plaintext state in advance or may be stored in a state in which it is encrypted using a cypher specific to the user terminal 200 of a pickup and delivery user. When the key ID is stored in the encrypted state, the encrypted key ID may be decrypted using the authentication information transmitted from the user terminal 200 of a pickup and delivery user to acquire the original key ID.

In this way, the onboard device 11 performs a sequence of processes of performing the authentication process using the key unit 100, operating the locking/unlocking device 300, and locking or unlocking the passenger compartment or the cargo compartment of the shared vehicle 10 with the authentication information transmitted from the user terminal 200 as a trigger. This sequence of processes is a locking/unlocking process by the onboard device 11.

The user terminal 200 of a pickup and delivery user will be described now. The user terminal 200 is a small computer such as a smartphone, a mobile phone, a tablet terminal, a personal information terminal, or a wearable computer (such as a smart watch). The user terminal 200 may be a personal computer (PC) that is connected to the pickup and delivery management server 500 via the network N1 such as the Internet which is a public communication network. The user terminal 200 of a pickup and delivery user includes a short-range communication unit 201, a communication unit 202, a control unit 203, and an input and output unit 204.

The short-range communication unit 201 is means that communicates with the key unit 100 using the same communication standard as the short-range communication unit 103 of the key unit 100. A network which is set up between the short-range communication unit 201 and the key unit 100 is illustrated as N2 in FIG. 1. The communication unit 202 is communication means that connecting the user terminal 200 to the network N1. In this embodiment, the user terminal 200 can communicate with another device (for example, the pickup and delivery management server 500) via the network N1 using a mobile communication service such as 3G (3^{rd} Generation) or LTE (Long Term Evolution).

The control unit 203 is a computer that takes charge of control of the user terminal 200. The control unit 203 performs, for example, a process of acquiring the terminal authentication information, a process of generating a locking/unlocking request including the acquired terminal authentication information, a process of transmitting the generated locking/unlocking request to the key unit 100, and a process of calculating a position of the user terminal 200, that is, a position of a pickup and delivery user, using a GPS system (not illustrated) disposed in the user terminal 200. The control unit 203 is constituted, for example, by a microcomputer, and the functions of performing the above-mentioned processes are realized by causing a CPU (not illustrated) to execute a program stored in storage means (such as a ROM).

The control unit 203 performs an interaction with the pickup and delivery user via the input and output unit 204. Similarly to the input and output unit 63 of the user terminal 60, the input and output unit 204 is means that receives an input operation which has been performed by the pickup and delivery user and provides information to the pickup and delivery user. The control unit 203 displays an operation screen on the input and output unit 204 and generates a locking/unlocking request based on an operation which has been performed by the pickup and delivery user. For example, the control unit 203 outputs an icon for unlocking, an icon for locking, and the like to a touch panel display and generates an unlocking request or a locking request based on the operation which has been performed by the pickup and delivery user. The operation which is performed by the pickup and delivery user is not limited to an operation using the touch panel display. For example, the operation may be performed using a hardware switch.

The control unit 203 performs a process of acquiring terminal authentication information from the center server 400. The terminal authentication information is not information (the key ID) for allowing the locking/unlocking device 300 to authenticate the key unit 100, but information for allowing the key unit 100 to authenticate the user terminal 200 (for example, authentication information corresponding to the authentication information specific to the key unit 100 mounted in the shared vehicle 10). Specifically, the control unit 203 transmits a request for issuance of terminal authentication information to the center server 400 via the pickup and delivery management server 500 using the communication unit 202. Here, the “request for issuance of terminal authentication information” includes a signal for requesting issuance of terminal authentication information specific to the key unit 100 along with identification information of the user terminal 200. The center server 400 receiving the request for issuance of terminal authentication information transmits terminal authentication information specific to the key unit 100 mounted in the shared vehicle 10 to the user terminal 200. Accordingly, an operation for unlocking the shared vehicle 10 can be performed in the user terminal 200. When the user terminal 200 does not include terminal authentication information, a locking operation and an unlocking operation on the operation screen for the shared vehicle 10 is not possible.

In this embodiment, the terminal authentication information acquired by the user terminal 200 may be a one-time key which is invalidated with locking of the cargo compartment based on ending of the pickup and delivery work of a pickup and delivery user as a trigger. For example, the terminal authentication information is stored in a storage unit (not illustrated) of the user terminal 200 at a time at which the terminal authentication information transmitted from the center server 400 is received by the user terminal 200, and then the terminal authentication information is deleted from the storage unit at a time at which a locking notification transmitted from the key unit 100 when locking of the cargo compartment door based on ending of the pickup and delivery work has been performed is received by the user terminal 200.

The time at which the terminal authentication information stored in the storage unit of the user terminal 200 is deleted is not limited to the above-mentioned example, but may be a time at which a predetermined time has elapsed from a time point at which the terminal authentication information transmitted from the center server 400 is received by the user terminal 200 (or a time point at which the terminal authentication information is transmitted from the center server 400 to the user terminal 200). The terminal authentication information is not limited to the above-mentioned one-time key, and may be a limited key which is validated in only a predetermined time zone. Regardless of whether the terminal authentication information is a one-time key or a limited key, device authentication information corresponding to the terminal authentication information is assumed to be stored in the key unit 100 in advance.

The user terminal 50 of a request user will be described below. Similarly to the user terminal 60 or the user terminal 200, the user terminal 50 may be, for example, a small computer such as a smartphone, a mobile phone, a tablet terminal, a personal information terminal, or a wearable computer (such as a smart watch) or may be a personal computer (PC). The user terminal 50 of a request user includes a communication unit 51, a control unit 52, and an input and output unit 53.

The communication unit 51 is communication means for connection to the network N1, which is functionally the same as the communication unit 202. The control unit 52 is a computer that takes charge of control of the user terminal 50. The control unit 52 is constituted, for example, by a microcomputer, and functions of performing various processes are realized by causing a CPU (not illustrated) to execute a program stored in storage means (such as a ROM). For example, the control unit 52 executes a predetermined application, and requests the pickup and delivery management server 500 to pick up and deliver of pickup and delivery luggage via the input and output unit 53. The input and output unit 53 is means that receives an input operation which has been performed by a request user and provides information to the request user, which is functionally the same as the input and output unit 204.

In FIG. 4, the user terminal 50 does not explicitly have an element corresponding to the short-range communication unit 201, but may include such an element, and the control unit 52 may be configured to operate the locking/unlocking device 300 using the user terminal 50 by performing a process of acquiring terminal authentication information from the center server 400 and transmitting the acquired terminal authentication information to the key unit 100 by short-range wireless communication, similarly to the control unit 203.

The pickup and delivery management server 500 will be described now. The pickup and delivery management server 500 has a general configuration of a computer and is, for example, a computer including a processor (not illustrated) such as a central processing unit (CPU) or a digital signal processor (DSP), a main storage unit (not illustrated) such as a random access memory (RAM) and a read only memory (ROM), and an auxiliary storage unit (not illustrated) such as an erasable programmable ROM (EPROM), a hard disk drive (HDD), and a removable medium. The removable medium is, for example, a universal serial bus (USB) memory or a disk recording medium such as a compact disc (CD) or a digital versatile disc (DVD). An operating system (OS), various programs, various tables, and the like are stored in the auxiliary storage unit, and functions matching a predetermined purpose can be realized by loading a program stored therein into a work area of the main storage unit, executing the loaded program, and controlling the constituent units through execution of the program.

The pickup and delivery management server 500 includes a communication unit 501. The communication unit 501 is connected to another device and performs communication between the pickup and delivery management server 500 and the other device (for example, the center server 400 or the user terminal 200). The communication unit 501 is, for example, a local area network (LAN) interface board and a wireless communication circuit for wireless communication. The LAN interface board or the wireless communication circuit is connected to the network N1 such as the Internet which is a public communication network.

The pickup and delivery management server 500 includes a pickup and delivery management database (DB) 503 that stores the pickup and delivery information. The pickup and delivery management DB 503 is configured to store pickup and delivery information in the auxiliary storage unit in which correlation between the request user and the pickup and delivery information is performed. The pickup and delivery management DB 503 is constructed by causing a program of a database management system (DBMS) which is executed by the processor to manage data stored in the auxiliary storage unit. The pickup and delivery management DB 503 is, for example, a relational database.

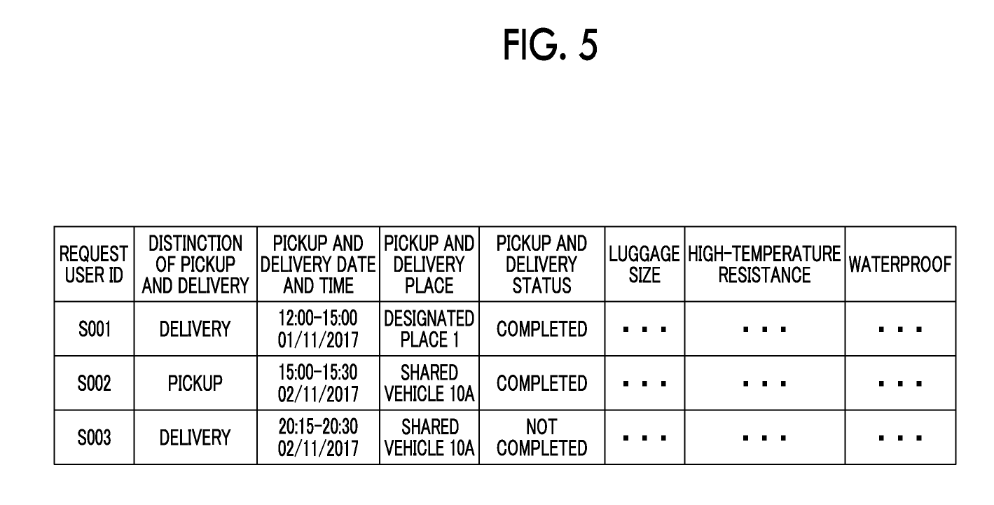

A configuration of pickup and delivery information stored in the pickup and delivery management DB 503 will be described below with reference to FIG. 5. FIG. 5 illustrates a table configuration of pickup and delivery information, and a pickup and delivery information table includes fields of request user ID, distinction of pickup and delivery, pickup and delivery date and time, pickup and delivery place, pickup and delivery status, luggage size, high temperature resistance, and waterproof. Identification information for identifying a request user is input to the field of request user ID. Information for specifying whether pickup and delivery luggage is delivered or picked up by a pickup and delivery user is input to the field of distinction of pickup and delivery user. Information indicating a date and time (a predetermined time zone) in which pickup and delivery luggage is picked up and delivered is input to the field of pickup and delivery date and time. Information indicating a place in which pickup and delivery luggage is picked up and delivered is input to the field of pickup and delivery place. When it is intended to input the shared vehicle 10 to the field of pickup and delivery place, that is, when it is intended for a request user to use the shared vehicle 10 as a pickup and delivery place, it is necessary to determine the shared vehicle 10 as the pickup and delivery place under the pickup and delivery control by the center server 400 which will be described later. Information indicating whether pickup and delivery of pickup and delivery luggage has been completed by a pickup and delivery user is input to the field of pickup and delivery status. For example, “completed” is input when the pickup and delivery of pickup and delivery luggage has been completed, and “not completed” is input thereto when the pickup and delivery has not been completed.

Information indicating a size of pickup and delivery luggage is input to the field of pickup and delivery luggage size. Information indicating whether there is no problem even when the pickup and delivery luggage is in a high-temperature environment (for example, equal to or higher than 40°) is input to the field of high temperature resistance. Information indicating whether there is no problem even when the pickup and delivery luggage gets wet is input to the field of waterproof. Regarding attribute information of pickup and delivery luggage including the luggage size, the high temperature resistance, and the waterproof, the attribute information of pickup and delivery luggage may be acquired from a product purchase site when a request user has purchased a product which is delivered as the pickup and delivery luggage from the product purchase site, or a request user may provide the attribute information of pickup and delivery luggage to the pickup and delivery management server 500 via the user terminal 50 when the request user requests to pick up the pickup and delivery luggage.

In the pickup and delivery management server 500, the control unit 502 is embodied as a functional unit by causing the processor to execute a program. The control unit 502 performs management control such as registration or update of pickup and delivery information in the pickup and delivery management DB 503. For example, when a request user requests to pick up and deliver pickup and delivery luggage via the user terminal 50 thereof, the identification information of the request user is corrected with a pickup and delivery date and time, a pickup and delivery place, and the like to generate pickup and delivery information corresponding to the request user and the generated pickup and delivery information is stored in the pickup and delivery management DB 503. When information change of the pickup and delivery date and time or the pickup and delivery place has been notified from the request user after the pickup and delivery information has been generated, the stored pickup and delivery information is updated to correspond to the change. As described above, in order to set the shared vehicle 10 as a pickup and delivery place, the control unit 502 cooperates with the control unit 402 of the center server 400 via the communication unit 501. The control unit 502 communicates with the user terminal 200 of a pickup and delivery user via the communication unit 501, and updates information on the status of the pickup and delivery luggage included in the pickup and delivery information. For example, status information (for example, information indicating completion of pickup and delivery) input by the pickup and delivery user via the input and output unit 204 is received from the user terminal 200 and corresponding pickup and delivery information is updated. The control unit 502 transmits a pickup and delivery instruction to the user terminal 200 such that the pickup and delivery user picks up or delivers the pickup and delivery luggage at the shared vehicle 10 based on the pickup and delivery information.

One of the functional units of the pickup and delivery management server 500 or some processes thereof may be embodied by another computer that is connected to the network N1. A sequence of processes which are performed by the pickup and delivery management server 500 may be embodied in hardware or may be embodied in software.

The center server 400 will be described below. The center server 400 has a general configuration of a computer, and a basic hardware configuration thereof is the same as the pickup and delivery management server 500 and includes a processor, a main storage unit, and an auxiliary storage unit which are not illustrated. Functions matching a predetermined purpose can be realized by loading a program stored in the auxiliary storage unit into a work area of the main storage unit, executing the loaded program, and controlling the constituent units through execution of the program. The center server 400 includes a communication unit 401. The communication unit 401 is functionally the same as the communication unit 501 of the pickup and delivery management server 500 and performs communication between the center server 400 and another device (for example, the sharing management server 600 or the pickup and delivery management server 500).

The center server 400 includes a user information DB 403 and an authentication information DB 404 that stores a variety of information in the auxiliary storage unit. Such databases (DB) are constructed by causing a program of a database management system which is executed by the processor to manage data stored in the auxiliary storage unit. The user information DB 403 and the authentication information DB 404 are, for example, relational databases.

The user information DB 403 stores identification information of a user using the shared vehicle 10 (a pickup and delivery user who delivers pickup and delivery luggage to the shared vehicle 10 or the like or a request user who recovers the delivered pickup and delivery luggage) for the purpose of pickup and delivery of pickup and delivery luggage, a corresponding password, and the like.

The authentication information DB 404 stores authentication information of the shared vehicle 10 which corresponds to the terminal authentication information. The authentication information of the shared vehicle 10 is information which is correlated with identification information (a key ID) of the shared vehicle 10 and may be, for example, identification information specific to the key unit 100 of the onboard device 11. The authentication information DB 404 may store information on an available period (which includes available time zones) of the authentication information, whether the authentication information is invalidated, and the like in addition to the authentication information of the shared vehicle 10. The available period of the authentication information may be transmitted along with the authentication information to the user terminal 200 of the pickup and delivery user. When the available period of the authentication information is received, the user terminal 200 of the pickup and delivery user can delete and invalidate the authentication information of which the available period has expired. Whether the authentication information is invalidated represents whether the authentication information has been transmitted to the user terminal 200 and has been in a valid state or the available period has expired and the authentication information has been in an invalid state. When the authentication information has been transmitted to the user terminal 200 and has been in a valid state, an authentication information managing unit 4021 which will be described later can avoid duplicate issuance of the authentication information by preventing the authentication information from being issued with the available period duplicate.

In the center server 400, a control unit 402 is embodied as a functional unit by causing the processor to execute a program. The control unit 402 performs control associated with issuance of authentication information to the user terminal 200 or the like or control of determining a pickup and delivery place of pickup and delivery luggage as a preliminary step of the issuance. Specifically, the control unit 402 includes an authentication information managing unit 4021, an extraction unit 4022, an inquiry unit 4023, a determination unit 4024, and an occupancy rate information acquiring unit 4025 as functional units.

The authentication information managing unit 4021 manages issuance of authentication information for locking and unlocking the shared vehicle 10 in order to pick up and deliver pickup and delivery luggage at the shared vehicle 10. For example, the authentication information managing unit 4021 receives an issuance request of authentication information for locking and unlocking the shared vehicle 10 from the user terminal 200 of a pickup and delivery user via the pickup and delivery management server 500. The issuance request includes identification information for identifying the shared vehicle 10 which is to be locked and unlocked. The authentication information managing unit 4021 receives information of the user terminal 200 which is an issuance destination of the authentication information along with the issuance request for the authentication information. In consideration of these, the authentication information managing unit 4021 transmits authentication information (terminal authentication information) corresponding to the key unit 100 mounted in the shared vehicle 10 which is to be locked and unlocked to the user terminal 200 via the pickup and delivery management server 500. At this time, the authentication information managing unit 4021 may generate authentication information including information of an available period. When the authentication information including information of an available period has been received but the available period has expired, the key unit 100 determines that the authentication information has been invalidated and prohibits locking and unlocking of the shared vehicle 10.

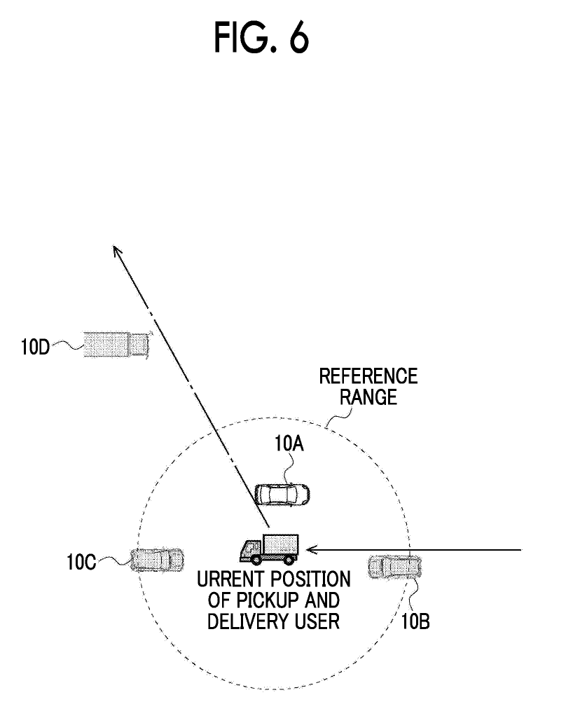

The extraction unit 4022, the inquiry unit 4023, the determination unit 4024, and the occupancy rate information acquiring unit 4025 will be described below. These functional units are not functional units associated with issuance of authentication information but functional units for realizing pickup and delivery control for determining a shared vehicle 10 as a pickup and delivery place of pickup and delivery luggage, which is illustrated in FIG. 6. First, the extraction unit 4022 extracts a vehicle (hereinafter referred to as a “target vehicle”) which is available for picking up and delivering pickup and delivery luggage from shared vehicles 10 which are managed by the sharing management server 600. A target vehicle is a vehicle which is not scheduled to be car-shared within a predetermined time range from the current time and which has a trunk (a cargo compartment) with a size capable of accommodating the pickup and delivery luggage. Specifically, the extraction unit 4022 accesses carsharing management information of the sharing management DB 603 of the sharing management server 600 (see FIG. 3A). A vehicle which is not scheduled to be used for carsharing within a predetermined time range from the current time is extracted as a temporary target vehicle based on an input value of the field of usage date and time in the management information. The predetermined time range mentioned herein is a limited time range from the current time which is set to achieve an improvement in an occupancy rate by using the shared vehicle 10 for pickup and delivery of luggage without hindering the carsharing of the shared vehicle 10, that is, a time range in the relatively near future. For example, a relatively short time such as 30 minutes or one hour may be exemplified.

The extraction unit 4022 accesses pickup and delivery information of the pickup and delivery management DB 503 of the pickup and delivery management server 500 (see FIG. 5) and ascertains the size of the corresponding pickup and delivery luggage input to the field of luggage size therein. In the target vehicles which are temporarily extracted, the target vehicles are narrowed to vehicles having a trunk capable of accommodating the pickup and delivery luggage. At this time, an input of the field of trunk size in the vehicle management information of the sharing management DB 603 is used (see FIG. 3B). Determination of whether the pickup and delivery luggage can be accommodated can be performed, for example, based on whether the trunk size of the vehicle is larger by a predetermined proportion or more than the size of the pickup and delivery luggage.

The extraction unit 4022 extracts a final target vehicle based on the current position of a pickup and delivery user from the temporary target vehicles narrowed based on the size of the pickup and delivery luggage as described above. This extraction of the target vehicle will be described below with reference to FIG. 6. It is assumed that a vehicle of a pickup and delivery user moves to the current position along a solid arrow and then moves along an arrow of an alternated long and short dash line. For example, the solid arrow indicates a route along which the pickup and delivery user travels based on pickup and delivery of luggage up to the current time, and the arrow of the alternated long and short dash line indicates a route along which the pickup and delivery user will travel based on pickup and delivery of luggage which is scheduled after the current time. Four vehicles illustrated in FIG. 6 are shared vehicles 10A to 10D which are available for picking up and delivering pickup and delivery luggage within the predetermined time range from the current time in accordance with the above-mentioned order.

A positional relationship of four shared vehicles with respect to the current position of the pickup and delivery user will be described now. The shared vehicle 10A is located with a reference range from the pickup and delivery user. The reference range is set as a range in which the pickup and delivery user can move easily in consideration of convenience for the pickup and delivery user, and is more specifically set as a range in which the pickup and delivery user can move within the predetermined time range from the current time. For example, the reference range may be set to be within a radius of 1 km from the current position of the pickup and delivery user. The shared vehicle 10A is located the closest to the pickup and delivery user among the four shared vehicles and located in the vicinity of the route along which the pickup and delivery user will pass after the current time. The shared vehicle 10B is also located within the reference range, but is located in an area through which the pickup and delivery user has already passed (an area along the solid arrow). The shared vehicle 10C is located within the reference range, but the distance from the route along which the pickup and delivery user will travel after the current time is larger than that of the shared vehicle 10A. The shared vehicle 10D is located outside the reference range and the distance from the pickup and delivery user is the largest among the four shared vehicles.

The extraction unit 4022 extracts a final target vehicle based on the current position of the pickup and delivery user as described above. Regarding the current position of the pickup and delivery user, when the current position of the user terminal 200 is calculated by the control unit of the user terminal 200 as described above and the calculated current position is provided to the center server 400 via the pickup and delivery management server 500, the provided current position can be used as the current position of the pickup and delivery user by the extraction unit 4022. In the extraction, the shared vehicle 10 located within the reference range from the pickup and delivery user may be extracted as the final target vehicle by the extraction unit 4022. Accordingly, in the state illustrated in FIG. 6, the shared vehicles 10A, 10B, and 10C are extracted as target vehicles.

In another method, from the shared vehicles 10 located within the reference range, the target vehicles may be further narrowed in accordance with a predetermined criterion. For example, when the pickup and delivery user intends to move to the shared vehicle 10B which is located in the area through which the pickup and delivery user has already passed, the pickup and delivery user has to return along the route and thus there is a likelihood that pickup and delivery of luggage in the future will be hindered. Accordingly, the shared vehicle 10B may not be extracted as the target vehicle. The shared vehicle 10C is relatively separated from the route along which the pickup and delivery user is scheduled to travel, and there is a likelihood that pickup and delivery of luggage in the future will be hindered when the pickup and delivery user intends to move to the shared vehicle 10C. Therefore, when a shared vehicle 10 is located separated a predetermined distance or more from the scheduled route, the shared vehicle may not be extracted as a target vehicle even if it is located with the reference range.

The inquiry unit 4023 notifies the user terminal 50 of a request user of position information of the target vehicle extracted by the extraction unit 4022 and an accessible time which is a time in which the target vehicle is accessible for picking up and delivering pickup and delivery luggage. Regarding the position information of the target vehicle, the inquiry unit 4023 accesses vehicle management information stored in the sharing management DB 603 of the sharing management server 600 and acquires position information of the position at which the target vehicle is parked based on an input value of the field of vehicle parking lot position as the position information of the target vehicle. Regarding the accessible time, since it is assumed that the pickup and delivery user can reach the target vehicle within the predetermined time range, the inquiry unit 4023 acquires a partial or entire time range belonging to the predetermined time range as the accessible time. For example, when the predetermined time range is one hour from the current time, one hour may be divided into four parts and one part thereof may be employed as the accessible time. The inquiry unit 4023 notifies the user terminal 50 of the request user of the position information of the target vehicle and the accessible time. When there are a plurality of target vehicles extracted, the corresponding position information and the corresponding accessible time are notified for each target vehicle.

The inquiry unit 4023 inquires of the request user about whether to pick up and deliver luggage at the notified target vehicle along with the notification. Specifically, the inquiry unit 4023 displays a list of corresponding position information and accessible times for one or more extracted target vehicles on the input and output unit 53 of the user terminal of the request user and promotes the request user to select one target vehicle or to reject all the notified target vehicles. That is, the inquiry from the inquiry unit 4023 is to inquire of the request user about whether to pick up and deliver pickup and delivery luggage using a target vehicle located in a place which the request user can reach within a predetermined time range from the current position of the request user. Then, the inquiry unit 4023 acquires a response of the request user to the inquiry from the user terminal 50.

When a plurality of accessible times can be set within the predetermined time range from the current time (for example, when the predetermined time range is a range of one hour from the current time and the range is divided into four parts to set accessible times of 15 minutes as described above), the inquiry unit 4023 may notify the request user of a plurality of accessible times including all the parts instead of notifying the request user of one accessible time thereof and may allow the request user to select one accessible time therefrom. According to this configuration, it is possible to enhance convenience for the request user and to appropriately improve the occupancy rate of the shared vehicles 10.

Then, the determination unit 4024 determines that the target vehicle selected by the request user as a place in which pickup and delivery of luggage is performed based on the response from the request user acquired by the inquiry unit 4023. This determination result is transmitted from the determination unit 4024 to the control unit 502 of the pickup and delivery management server 500, and is reflected in the field of pickup and delivery place of the pickup and delivery information illustrated in FIG. 5. That is, since the shared vehicle 10A is determined to be the pickup and delivery place by the determination unit 4024, the shared vehicle 10A is input to the field of pickup and delivery place in the pickup and delivery information illustrated in FIG. 5.

Then, the occupancy rate information acquiring unit 4025 calculates a ratio at which the target vehicle extracted by the extraction unit 4022 is shared in a predetermined period over a plurality of days (for example, one month in this embodiment) for each hour. Specifically, the occupancy rate information acquiring unit 4025 acquires occupancy rate information calculated by the occupancy rate calculating unit 6022 of the sharing management server 600 from the sharing management server 600. An example of the occupancy rate information is illustrated in FIG. 9, and details thereof will be described later.

One of the functional elements of the center server 400 or some of the processes thereof may be embodied by another computer connected to the network N1. A sequence of processes which are performed by the center server 400 may be implemented in hardware or may be implemented in software.

### Process Flow

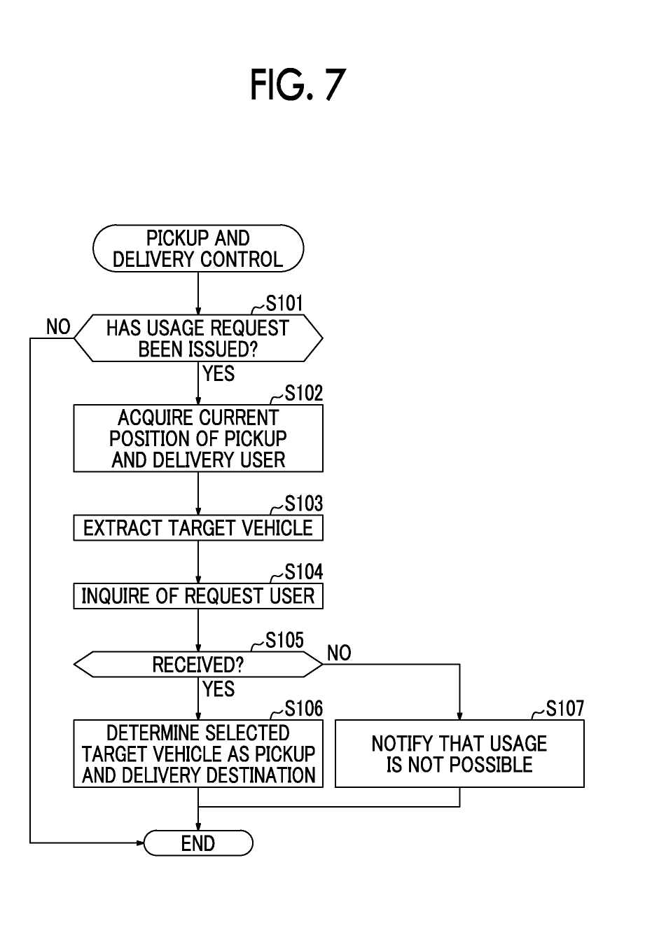

FIG. 7 illustrates a flow of pickup and delivery control which is repeatedly executed at predetermined intervals by the center server 400. In the following description of the process flow of pickup and delivery control, for example, it is assumed that a request user requests a pickup and delivery user to deliver pickup and delivery luggage. This does not intend to limit pickup and delivery work by the pickup and delivery user to delivery of the pickup and delivery luggage. In this embodiment, it is assumed that pickup and delivery luggage including a product purchased in a product purchase site is scheduled to be delivered to a place other than a shared vehicle 10 in the request user's house at the time of purchasing the product by a request from the request user. It is assumed that a pickup and delivery user loads the pickup and delivery luggage at the pickup and delivery user's vehicle in accordance with the schedule and moves to the scheduled delivery destination.

First, in S101, it is determined whether there is a request for a shared vehicle 10 from a request user, that is, a request to use the shared vehicle 10 at the delivery destination in delivery of pickup and delivery luggage from the request user. Specifically, when the request user requests the pickup and delivery management server 500 to change the original delivery destination to a shared vehicle 10 using the user terminal 50, the control unit 502 transmits a usage request for a shared vehicle 10 to the center server 400. Accordingly, when the control unit 402 of the center server 400 receives the usage request, the determination result of S101 is positive and the process flow transitions to S102. On the other hand, when the control unit 402 does not receive the usage request, the determination result of S101 is negative and the pickup and delivery control ends.

In S102, the extraction unit 4022 acquires the current position of the pickup and delivery user. Subsequently, in S103, a target vehicle is extracted from shared vehicles 10 which are managed by the sharing management server 600 based on the current position of the pickup and delivery user acquired by the extraction unit 4022. This extraction is the same as described above with reference to FIG. 6. In this embodiment, it is assumed that three shared vehicles 10A, 10B, and 10C located within the reference range from the pickup and delivery user are extracted as target vehicles as illustrated in FIG. 6. When the process of S103 is completed, the process flow transitions to S104.

In S104, the inquiry unit 4023 notifies the user terminal 50 of the request user of the position information and the accessible time for each of the extracted target vehicles and inquires about whether to pick up and deliver the pickup and delivery luggage at the target vehicles. In response to this inquiry, the request user returns a response indicating to which target vehicle the pickup and delivery luggage is delivered or whether to reject the pickup and delivery luggage to any target vehicle using the user terminal 50. The request user can return a response in consideration of personal circumstances, for example, in consideration of whether the request user can reach the extracted target vehicle within the accessible time. The response is transmitted via the input and output unit 53 of the user terminal 50, and the response result is transmitted from the user terminal 50 to the center server 400.

Subsequently, in S105, in consideration of the response result, it is determined whether the response from the request user indicates that the extracted target vehicle is accepted as a new delivery destination. This determination is performed by the determination unit 4024. The process flow transitions to S106 when the determination result of S105 is positive, and the process flow transitions to S107 when the determination result is negative. Then, in S106, the determination unit 4024 determines that the target vehicle (for example, the shared vehicle 10A) selected by the request user is a new delivery destination instead of the original delivery destination. The determined new delivery destination is transmitted to the pickup and delivery management server 500 and is reflected in the pickup and delivery information. On the other hand, when the target vehicle is not selected as a new delivery destination by the request user, the determination unit 4024 notifies the user terminal 50 of the request user that the shared vehicle 10 cannot be used as a new delivery destination in S107.

In this way, according to the pickup and delivery control, a shared vehicle 10 which is available for picking up and delivering the pickup and delivery luggage in a limited time within a predetermined time range from the current time is used for the pickup and delivery. As a result, it is possible to improve the occupancy rate of the shared vehicles 10 by efficiently using the shared vehicles 10 for picking up and delivering luggage while avoiding hindrance of use in carsharing of the shared vehicles 10 which are managed by the carsharing system as much as possible. In using a shared vehicle 10 for pickup and delivery of luggage, since the current position of a pickup and delivery user is considered and a request user has an opportunity to return a response indicating whether to use the target vehicle, it is possible to avoid damage of convenience of the pickup and delivery user and the request user as much as possible.

When the delivery destination has changed to the shared vehicle 10A by the pickup and delivery control, the pickup and delivery user reaches a parking lot at which the shared vehicle 10A is parked based on the position information of the shared vehicle 10A, and requests the center server 400 to issue authentication information corresponding to the shared vehicle 10A using the user terminal 200 of the pickup and delivery user. When the request is transmitted to the center server 400, the authentication information managing unit 4021 issues the corresponding authentication information to the user terminal 200, and the pickup and delivery user receiving the authentication information can lock and unlock the cargo compartment of the shared vehicle 10A using the received authentication information.

### Modified Example 1

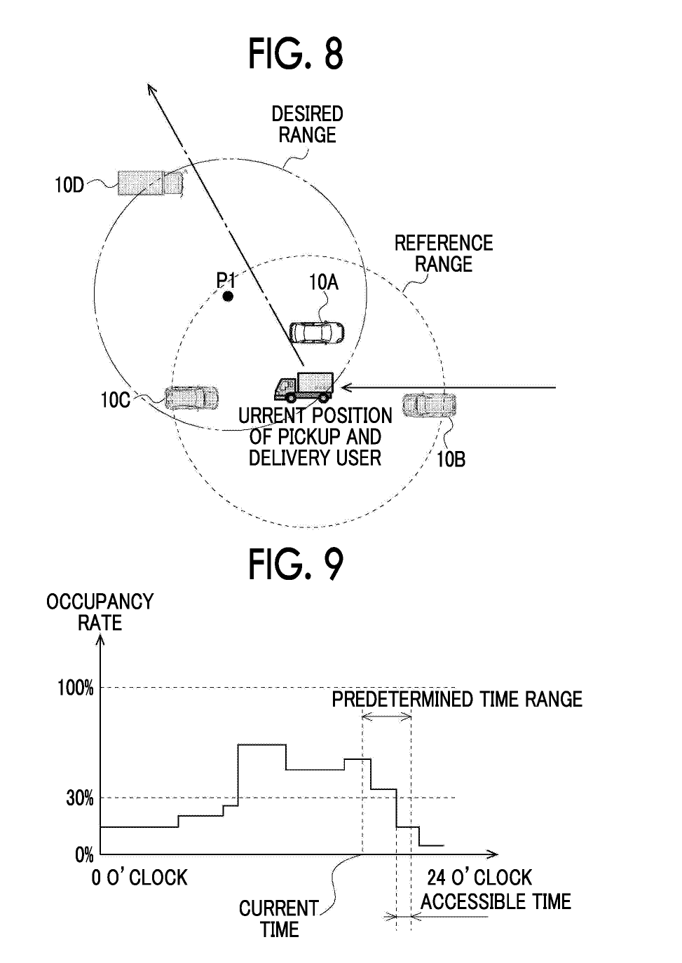

Modified Example 1 of the embodiment will be described below. In the above-mentioned embodiment, the current position of a pickup and delivery user is considered in extraction of a target vehicle by the extraction unit 4022, but a pickup and delivery position desired by the request user is additionally considered in extraction of a target vehicle in this modified example. Therefore, extraction of a target vehicle in this modified example will be described below with reference to FIG. 8. The positional relationship between four shared vehicles (the shared vehicles 10A to 10D which are available for picking up and delivering pickup and delivery luggage within a predetermined time range from the current time) from the current position of the pickup and delivery user is substantially the same as illustrated in FIG. 6.

The pickup and delivery place desired by the request user is also transmitted to the pickup and delivery management server 500 at the same time as transmitting the request for change of the delivery destination (the request for use of the shared vehicle 10 as a new delivery destination) from the user terminal 50 of the request user to the pickup and delivery management server 500. The pickup and delivery management server 500 transmits information on the desired pickup and delivery place to the center server 400, and the extraction unit 4022 ascertains the desired pickup and delivery place. In FIG. 8, the desired pickup and delivery place ascertained by the extraction unit 4022 is indicated by P1.

Then, the extraction unit 4022 may extract a shared vehicle 10 which is located within a desired range which is a constant range from the desired pickup and delivery place and located within the reference range from the pickup and delivery user as a final target vehicle. That is, extraction of a target vehicle is performed in consideration of convenience for both the request user and the pickup and delivery user. Accordingly, in the state illustrated in FIG. 8, the shared vehicles 10A and 10C are extracted as the target vehicles. After the target vehicles have been extracted, the processes by the inquiry unit 4023 and the determination unit 4024 are performed as described in the above-mentioned embodiment.

### Modified Example 2

Modified Example 2 of the embodiment will be described below. In the above-mentioned embodiment, the target vehicles are narrowed based on the size of pickup and delivery luggage. However, in this modified example, target vehicles suitable for pickup and delivery of the pickup and delivery luggage may be extracted based on attributes of the pickup and delivery luggage, that is, high temperature resistance or waterproof of the pickup and delivery luggage. Specifically, when pickup and delivery luggage having poor high temperature resistance (pickup and delivery luggage which is not desirably put in a high-temperature environment) or pickup and delivery luggage having poor waterproof (pickup and delivery luggage which is not desirably wet) is to be picked up and delivered, the extraction unit 4022 accesses the vehicle management information of the sharing management DB 603 and narrows candidates for the target vehicle to vehicles in which the input value in the field of parking lot attribute is set to “indoor.” This is because a shared vehicle 10 parked indoor is put in an environment which is shielded from direct sunlight, rainfall, or the like.

### Modified Example 3

Modified Example 3 of the above-mentioned embodiment will be described below. In this modified example, the accessible time notified from the inquiry unit 4023 is determined based on the occupancy rate in the carsharing system of the corresponding target vehicle. Determination of the accessible time will be described with reference to FIG. 9. FIG. 9 illustrates change of the occupancy rate of one target vehicle extracted by the extraction unit 4022 over time in a day. The change of the occupancy rate is information acquired from the sharing management server 600 by the occupancy rate information acquiring unit 4025.

The predetermined time range from the current time includes a time zone in which an actual occupancy rate is equal to or higher than a target occupancy rate (30%) and a time zone in which the actual occupancy rate is less than the target occupancy rate. Therefore, from the viewpoint of improvement in the occupancy rate of a target vehicle, a time zone in which the actual occupancy rate is less than the target occupancy rate may be employed as the accessible time for the extracted target vehicle. In a time zone in which the occupancy rate is relatively high (a time zone in which the actual occupancy rate is equal to or higher than the target occupancy rate), there is a higher likelihood that a shared vehicle which is not used for carsharing at the current time (which is not reserved for use for carsharing) will be used for carsharing after the current time than in a time zone in which the occupancy rate is relatively low (a time zone in which the actual occupancy rate is less than the target occupancy rate). Therefore, by setting the accessible time used for picking up and delivering pickup and delivery luggage to a time zone in which the actual occupancy rate is less than the target occupancy rate, it is possible to efficiently use the shared vehicle 10 for picking up and delivering luggage while avoiding hindrance of use for carsharing as much as possible.

### Modified Example 4

In the above-mentioned embodiment, when a shared vehicle 10 is used for picking up and delivering pickup and delivery luggage, the authentication information managing unit 4021 of the center server 400 issues authentication information for locking and unlocking the cargo compartment to the user terminal 200 of the pickup and delivery user. As well as in this aspect, even when a sharing user shares a shared vehicle 10 under the management of the sharing management server 600, the authentication information managing unit 4021 may issue authentication information corresponding to the shared vehicle 10 to the user terminal 60 of the sharing user. In this case, the issued authentication information serves as driving key information for driving the shared vehicle 10 as well as locking and unlocking the shared vehicle 10.

### Modified Example 5

In the above-mentioned embodiment, when the authentication process by the key unit 100 has succeeded, a shared vehicle 10 is unlocked by the locking/unlocking device 300 but the locking/unlocking device 300 may perform the process of the key unit 100 in this modified example. That is, the locking/unlocking device 300 may include a control unit (an ECU) that authenticates the authentication information received from the user terminal 200, and the control unit may transmit a locking command or an unlocking command to the body ECU 304 via an onboard network such as CAN when authentication of the user terminal 200 has succeeded.

According to this modified example, it is possible to pick up and deliver luggage at the cargo compartment of a shared vehicle 10 with a simple configuration in which the key unit 100 is not installed.

### Modified Example 6

In the above-mentioned embodiment, the user terminal 200 receives authentication information from the center server 400, a locking/unlocking signal is transmitted from the key unit 100 to the locking/unlocking device 300 when the user terminal 200 is authenticated by the key unit 100 based on the received authentication information, and the shared vehicle 10 is locked/unlocked. In this modified example, the authentication information includes information of a key ID for locking/unlocking the shared vehicle 10, not information for authenticating the user terminal 200.

In this case, the user terminal 200 receives authentication information including a key ID for locking/unlocking a shared vehicle 10 from the center server 400 via the pickup and delivery management server 500, and transmits the received key ID along with a locking/unlocking signal to the locking/unlocking device 300. The locking/unlocking device 300 compares the received key ID with a key ID stored in advance in the locking/unlocking device 300 and locks/unlocks the shared vehicle 10 when both key IDs match each other. The key ID is transmitted and received in an encrypted state between the user terminal 200 and the center server 400 or the locking/unlocking device 300. The authentication information managing unit 4021 of the center server 400 may generate a one-time key, for example, by encrypting the key ID along with time information using a predetermined algorithm. The locking/unlocking device 300 decrypts the received one-time key using the same predetermined algorithm as in the center server 400 and compares the decrypted one-time key with the key ID stored in advance in the locking/unlocking device 300.

By including the one-time key generated from the key ID and the time information in the authentication information, the center server 400 can generate authentication information which is temporarily valid for each issuance request and transmit the generated authentication information to the user terminal 200.

### Modified Example 7

In Modified Example 5, the center server 400 transmits authentication information for the user terminal 200 corresponding to fixed authentication information specific to the key unit 100 or the key ID stored in advance in the locking/unlocking device 300 of the shared vehicle 10 to the user terminal 200. However, authentication information transmitted between the user terminal 200 and the key unit 100 is not limited thereto. In this modified example, for example, the center server 400 may generate new authentication information and issue the new authentication information to the user terminal 200 when an issuance request is received from the user terminal 200. In this case, the center server 400 can transmit authentication information for the key unit 100 corresponding to the new authentication information for the user terminal 200 to the key unit 100 via a data communication device (not illustrated) mounted in the shared vehicle 10 and store the authentication information therein. In this case, the key unit 100 can be connected to the data communication device via the CAN or the like. In another method, the center server 400 may generate new authentication information from identification information for identifying the shared vehicle 10 and the time information and transmit the new authentication information and the time information to the user terminal 200. In this case, the key unit 100 can generate new authentication information using the same algorithm as in the center server 400. The user terminal 200 can transmit the new authentication information and the time information to the key unit 100 and be subjected to authentication.

### Recording Medium

A program causing a computer or other machine or device (hereinafter referred to as a computer or the like) to execute the issuance control can be recorded on a computer-readable recording medium. By causing the computer or the like to read and execute the program of the recording medium, the computer or the like serves as the center server 400.

Here, the computer-readable recording medium refers to a non-transitory computer-readable recording medium which can store information such as data or programs in an electrical, magnetic, optical, mechanical, or chemical action and be read by the computer or the like. Examples of the recording medium which can be detached from the computer or the like include a flexible disk, a magneto-optical disk, a CD-ROM, a CD-R/W, a DVD, a blu-ray disc, a DAT, a 8 mm tape, and a memory card such as a flash memory. Examples of the recording medium fixed to the computer or the like include a hard disk and a read only memory (ROM). A solid state drive (SSD) can be used as a recording medium which can be detached from the computer or the like and can also be used as a recording medium fixed to the computer or the like.

What is claimed is:

1. A pickup and delivery control system configured to perform pickup and delivery of luggage at a vehicle shared in carsharing, the pickup and delivery control system comprising:
an extraction unit configured to extract one or more target vehicles which are not being shared within a predetermined time range from a current time and which are usable for pickup and delivery of the luggage, from among a plurality of vehicles based on a current position of a pickup and delivery user who picks up and delivers the luggage;
an inquiry unit configured to notify a request user who requests pickup and delivery of the luggage of position information of the extracted target vehicle and an accessible time which is within the predetermined time range and at which the target vehicle is accessible and to inquire of the request user about whether to pick up and deliver the luggage at the target vehicle; and
a determination unit configured to determine a pickup and delivery place and a pickup and delivery time of the luggage based on an inquiry result from the inquiry unit.

2. The pickup and delivery control system according to claim 1, wherein the extraction unit is configured to extract the one or more target vehicles based on predetermined pickup and delivery information on the luggage.

3. The pickup and delivery control system according to claim 2, further comprising an occupancy rate information acquiring unit configured to acquire occupancy rate information on the one or more target vehicles within the predetermined time range from the current time,
wherein the inquiry unit is configured to notify the request user of a part or all of a time zone in which an occupancy rate is equal to or less than a predetermined occupancy rate as the accessible time when the time zone in which the occupancy rate is equal to or less than the predetermined occupancy rate is included in the predetermined time range.

4. The pickup and delivery control system according to claim 1, wherein the inquiry unit is configured to inquire of the request user such that one of a plurality of accessible times belonging to the predetermined time range is selected.

5. The pickup and delivery control system according to claim 1, wherein:
the luggage is scheduled to be picked up and delivered at a predetermined place associated with the request user by a pickup and delivery user; and
the extraction unit is configured to extract the target vehicle instead of the predetermined place as a new pickup and delivery place of the luggage when a request for changing the pickup and delivery place of the luggage from the predetermined place is issued from the request user.

6. A pickup and delivery control method for performing pickup and delivery of luggage at a vehicle shared in carsharing, the pickup and delivery control method comprising:
extracting one or more target vehicles which are not being shared within a predetermined time range from a current time and which are usable for pickup and delivery of the luggage, from among a plurality of vehicles based on a current position of a pickup and delivery user who picks up and delivers the luggage;
notifying a request user who requests pickup and delivery of the luggage of position information of the extracted target vehicle and an accessible time which is within the predetermined time range and at which the target vehicle is accessible and inquiring of the request user about whether to pick up and deliver the luggage at the target vehicle; and
determining a pickup and delivery place and a pickup and delivery time of the luggage based on an inquiry result.

7. The pickup and delivery control method according to claim 6, wherein the extracting of the one or more target vehicles includes extracting the one or more target vehicles based on predetermined pickup and delivery information on the luggage.

8. The pickup and delivery control method according to claim 7, further comprising acquiring occupancy rate information on the one or more target vehicles within the predetermined time range from the current time,
wherein the inquiring about whether to pick up and deliver luggage at the target vehicle includes notifying the request user of a part or all of a time zone in which an occupancy rate is equal to or less than a predetermined occupancy rate as the accessible time when the time zone in which the occupancy rate is equal to or less than the predetermined occupancy rate is included in the predetermined time range.
